(19) United States
(12) Patent Application Publication
(10) Pub. No.: US 2024/0272870 A1
(43) Pub. Date: Aug. 15, 2024

(54) DISPLAY DEVICE

(71) Applicant: LG ELECTRONICS INC., Seoul (KR)

(72) Inventor: Jeungrac LEE, Seoul (KR)

(73) Assignee: LG ELECTRONICS INC., Seoul (KR)

(21) Appl. No.: 18/258,594

(22) PCT Filed: Jan. 5, 2021
(86) PCT No.: PCT/KR2021/000041

§ 371 Date: Jun. 21, 2023

(51) Int. Cl. G06F 3/16; G10L 15/18; H04N 21/422; H04N 21/475; H04N 21/658

(52) U.S. Cl. CPC G06F 3/167; G10L 15/1815; H04N 21/42203; H04N 21/475; H04N 21/658

(57) ABSTRACT

A display device according to an embodiment of the present disclosure may comprise: a storage unit, a display unit, a network interface unit configured to communicate with a first server or a second server and a control unit configured to store voice data corresponding to a voice command uttered by a user in the storage unit, transmit the voice command to the first server, receive first analysis result information of the voice command from the first server, display a first result based on the received first analysis result information on the display unit, transmit the stored voice data to the second server if a user's feedback is received, receive a second analysis result information of a command from the second server, and display a second result based on the received second analysis result information on the display unit.

### TECHNICAL FIELD

The present disclosure relates to being able to provide voice recognition services through a plurality of artificial intelligence agents.

### BACKGROUND ART

Recently, many technologies have emerged that use artificial intelligence to recognize a user's speech and provide a voice recognition service suitable for the speech.

In general, a display device is equipped with a plurality of artificial intelligence (AI) agents (or assistants) capable of providing voice recognition service.

Along with the development of AI agent-related technologies and the increase in interest, various operators have begun to provide various types of AI agents.

While some AI agents can only be used on specific platforms, some AI agents have been developed to be compatible with multiple platforms, allowing customers to use different types of AI agents on one platform.

A method of providing an AI agent on a multi-AI agent platform may include a hybrid provision method and a user-selective provision method.

In the hybrid method, a specific agent is selected from among several AI agents according to the logic conceived by the supplier in response to the user's request and provides the result.

In the hybrid provision method, AI agents are selected by the optimal logic that the provider thinks, but if the domains that each agent can handle overlap or if a user wants to use a specific agent, there are restrictions that the desired result cannot be provided.

The user-selective provision method includes a selective method in which the user designates an AI agent to be initially used, and a method in which a key corresponding to each AI agent is separated and a desired AI agent is selected every moment (key separation type).

In the user-selective provision method, independent services of each AI agent can be provided compared to the hybrid provision method, but the domain supported by each service is different, which causes confusion in which service to use from the user's point of view.

In addition, in the user-selective provision method, if an AI agent is set in advance, only the selected AI agent is operated, and if another AI agent is to be used, there is an inconvenience in that the AI agent must be selected again.

### DISCLOSURE

### Technical Problem

The purpose of the present disclosure is to offset the disadvantages of a hybrid provision method and a user-selective provision method in an environment where multiple AI agents can be used.

An object of the present disclosure is to enable a user to easily use another AI agent if an unintended result is provided if a voice recognition service is provided through multiple AI agents.

An object of the present disclosure is to provide an improved user experience in which a plurality of AI agents interact with each other within a single platform.

### Technical Solution

A display device according to an embodiment of the present disclosure may comprise: a storage unit, a display unit, a network interface unit configured to communicate with a first server or a second server and a control unit configured to store voice data corresponding to a voice command uttered by a user in the storage unit, transmit the voice command to the first server, receive first analysis result information of the voice command from the first server, display a first result based on the received first analysis result information on the display unit, transmit the stored voice data to the second server if a user's feedback is received, receive a second analysis result information of a command from the second server, and display a second result based on the received second analysis result information on the display unit.

A display device according to an embodiment of the present disclosure may comprise: a display unit, a network interface unit configured to communicate with a first server or a second server and a control unit configured to transmit a voice data corresponding to a voice command spoken by a user to the first server, receive a first analysis result information of the voice command from the first server, display a first result based on the received first analysis result information on the display unit, receive a feedback from the user, transmit the received feedback to the first server, receive a second analysis result information of the voice command from the second server, display a second result based on the received second analysis result information on the display unit.

### Advantageous Effects

According to various embodiments of the present disclosure, even if a user does not obtain a desired result for a voice command from one AI agent, the user can easily obtain a desired result from another AI agent without needing to re-utter the voice command. Accordingly, the user can enjoy a more improved voice recognition experience.

According to an embodiment of the present disclosure, in response to a user's one-time utterance command, the display device 100 may provide the user with an effect in which the display device looks a bit smarter by giving an image that several AI assistants interact and talk with each other.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present invention.

FIG. 3 is a view illustrating an actual configuration of a remote control device according to an embodiment of the present invention.

FIG. 4 is a view of utilizing a remote control device according to an embodiment of the present invention.

FIG. 5 is a block diagram illustrating the configuration of an AI server according to an embodiment of the present disclosure.

FIG. 6 is a diagram for explaining the configuration of an artificial intelligence system according to another embodiment of the present disclosure.

FIG. 7 is a ladder diagram for a method of operating an artificial intelligence system according to an embodiment of the present disclosure.

FIG. 8 is a diagram explaining a process in which an artificial intelligence system operates in response to a voice command uttered by a user.

FIGS. 9 to 13 are diagrams illustrating examples of providing a second result according to a user's feedback on a first result according to various embodiments of the present disclosure.

FIG. 14 is a ladder diagram for a method of operating an artificial intelligence system according to another embodiment of the present disclosure.

### BEST MODE

Hereinafter, embodiments relating to the present disclosure will be described in detail with reference to the drawings. The suffixes “module” and “unit” for components used in the description below are assigned or mixed in consideration of easiness in writing the specification and do not have distinctive meanings or roles by themselves.

A display device according to an embodiment of the present invention, for example, as an artificial display device that adds a computer supporting function to a broadcast receiving function, can have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS can be used.

Accordingly, since various applications are freely added or deleted on a general purpose OS kernel, a display device described herein, for example, can perform various user-friendly functions. The display device, in more detail, can be a network TV, Hybrid Broadcast Broadband TV (HBBTV), smart TV, light-emitting diode (LED) TV, organic light-emitting diode (OLED) TV, and so on and in some cases, can be applied to a smartphone.

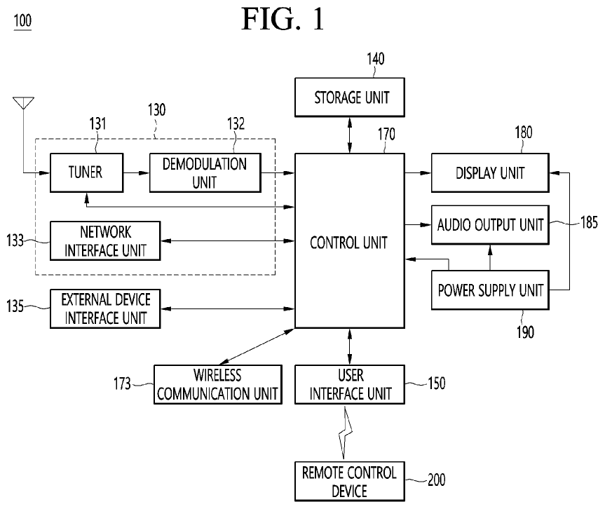

FIG. 1 is a block diagram illustrating a configuration of a display device according to an embodiment of the present invention.

Referring to FIG. 1, a display device 100 can include a broadcast reception unit 130, an external device interface unit 135, a storage unit 140, a user interface unit 150, a control unit 170, a wireless communication unit 173, a display unit 180, an audio output unit 185, and a power supply unit 190.

The broadcast reception unit 130 can include a tuner 131, a demodulation unit 132, and a network interface unit 133.

The tuner 131 can select a specific broadcast channel according to a channel selection command. The tuner 131 can receive broadcast signals for the selected specific broadcast channel.

The demodulation unit 132 can divide the received broadcast signals into video signals, audio signals, and broadcast program related data signals and restore the divided video signals, audio signals, and data signals to an output available form.

The external device interface unit 135 can receive an application or an application list in an adjacent external device and deliver it to the control unit 170 or the storage unit 140.

The external device interface unit 135 can provide a connection path between the display device 100 and an external device. The external device interface unit 135 can receive at least one an image or audio output from an external device that is wirelessly or wiredly connected to the display device 100 and deliver it to the control unit 170. The external device interface unit 135 can include a plurality of external input terminals. The plurality of external input terminals can include an RGB terminal, at least one High Definition Multimedia Interface (HDMI) terminal, and a component terminal.

An image signal of an external device input through the external device interface unit 135 can be output through the display unit 180. A sound signal of an external device input through the external device interface unit 135 can be output through the audio output unit 185.

An external device connectable to the external device interface unit 135 can be one of a set-top box, a Blu-ray player, a DVD player, a game console, a sound bar, a smartphone, a PC, a USB Memory, and a home theater system, but this is just exemplary.

The network interface unit 133 can provide an interface for connecting the display device 100 to a wired/wireless network including the Internet network. The network interface unit 133 can transmit or receive data to or from another user or another electronic device through an accessed network or another network linked to the accessed network.

Additionally, some content data stored in the display device 100 can be transmitted to a user or an electronic device, which is selected from other users or other electronic devices pre-registered in the display device 100.

The network interface unit 133 can access a predetermined webpage through an accessed network or another network linked to the accessed network. That is, the network interface unit 133 can transmit or receive data to or from a corresponding server by accessing a predetermined webpage through the network.

Then, the network interface unit 133 can receive contents or data provided from a content provider or a network operator. That is, the network interface unit 133 can receive contents such as movies, advertisements, games, VODs, and broadcast signals, which are provided from a content provider or a network provider, through network and information relating thereto.

Additionally, the network interface unit 133 can receive firmware update information and update files provided from a network operator and transmit data to an Internet or content provider or a network operator.

The network interface unit 133 can select and receive a desired application among applications open to the air, through network.

The storage unit 140 can store signal-processed image, voice, or data signals stored by a program in order for each signal processing and control in the control unit 170.

Additionally, the storage unit 140 can perform a function for temporarily storing image, voice, or data signals output from the external device interface unit 135 or the network interface unit 133 and can store information on a predetermined image through a channel memory function.

The storage unit 140 can store an application or an application list input from the external device interface unit 135 or the network interface unit 133.

The display device 100 can play content files (for example, video files, still image files, music files, document files, application files, and so on) stored in the storage unit 140 and provide them to a user.

The user interface unit 150 can deliver signals input by a user to the control unit 170 or deliver signals from the control unit 170 to a user. For example, the user interface unit 150 can receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user interface unit 150 can deliver, to the control unit 170, control signals input from local keys (not shown) such as a power key, a channel key, a volume key, and a setting key.

Image signals that are image-processed in the control unit 170 can be input to the display unit 180 and displayed as an image corresponding to corresponding image signals. Additionally, image signals that are image-processed in the control unit 170 can be input to an external output device through the external device interface unit 135.

Voice signals processed in the control unit 170 can be output to the audio output unit 185. Additionally, voice signals processed in the control unit 170 can be input to an external output device through the external device interface unit 135.

Besides that, the control unit 170 can control overall operations in the display device 100.

Additionally, the control unit 170 can control the display device 100 by a user command or internal program input through the user interface unit 150 and download a desired application or application list into the display device 100 in access to network.

The control unit 170 can output channel information selected by a user together with processed image or voice signals through the display unit 180 or the audio output unit 185.

Additionally, according to an external device image playback command received through the user interface unit 150, the control unit 170 can output image signals or voice signals of an external device such as a camera or a camcorder, which are input through the external device interface unit 135, through the display unit 180 or the audio output unit 185.

Moreover, the control unit 170 can control the display unit 180 to display images and control broadcast images input through the tuner 131, external input images input through the external device interface unit 135, images input through the network interface unit, or images stored in the storage unit 140 to be displayed on the display unit 180. In this case, an image displayed on the display unit 180 can be a still image or video and also can be a 2D image or a 3D image.

Additionally, the control unit 170 can play content stored in the display device 100, received broadcast content, and external input content input from the outside, and the content can be in various formats such as broadcast images, external input images, audio files, still images, accessed web screens, and document files.

Moreover, the wireless communication unit 173 can perform a wired or wireless communication with an external electronic device. The wireless communication unit 173 can perform short-range communication with an external device. For this, the wireless communication unit 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication unit 173 can detect (or recognize) a communicable wearable device around the display device 100. Furthermore, if the detected wearable device is a device authenticated to communicate with the display device 100, the control unit 170 can transmit at least part of data processed in the display device 100 to the wearable device through the wireless communication unit 173. Accordingly, a user of the wearable device can use the data processed in the display device 100 through the wearable device.

The display unit 180 can convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present invention and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present invention and its specific operation or device does not limit the scope of the present invention.

According to another embodiment of the present invention, unlike FIG. 1, the display device 100 can receive images through the network interface unit 133 or the external device interface unit 135 and play them without including the tuner 131 and the demodulation unit 132.

For example, the display device 100 can be divided into an image processing device such as a set-top box for receiving broadcast signals or contents according to various network services and a content playback device for playing contents input from the image processing device.

In this case, an operating method of a display device according to an embodiment of the present invention described below can be performed by one of the display device described with reference to FIG. 1, an image processing device such as the separated set-top box, and a content playback device including the display unit 180 and the audio output unit 185.

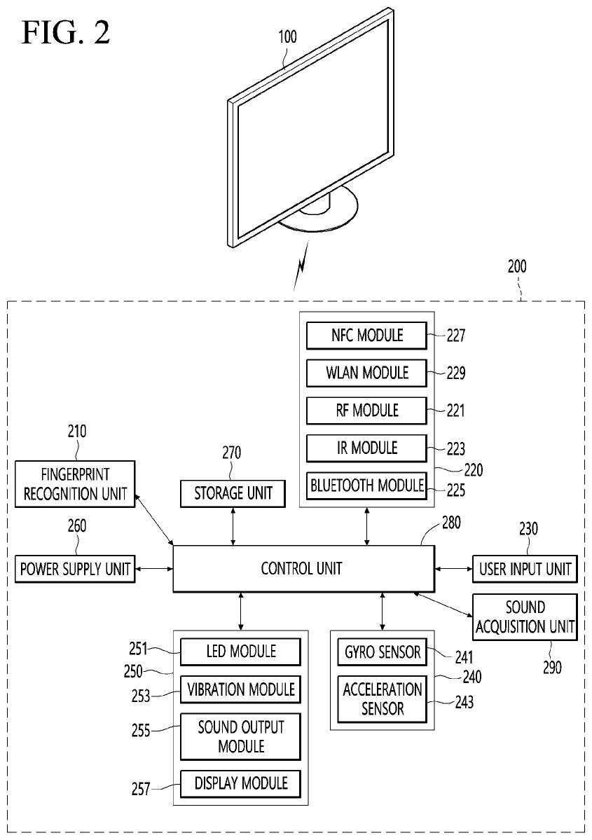

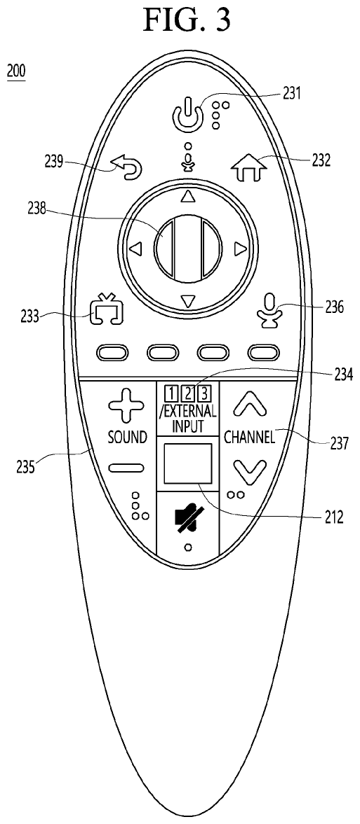

Then, referring to FIGS. 2 and 3, a remote control device is described according to an embodiment of the present invention.

FIG. 2 is a block diagram illustrating a remote control device according to an embodiment of the present invention and FIG. 3 is a view illustrating an actual configuration of a remote control device according to an embodiment of the present invention.

First, referring to FIG. 2, a remote control device 200 can include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present invention.

The remote control device 200 can include a radio frequency (RF) module 221 for transmitting/receiving signals to/from the display device 100 according to the RF communication standards and an IR module 223 for transmitting/receiving signals to/from the display device 100 according to the IR communication standards. Additionally, the remote control device 200 can include a Bluetooth module 225 for transmitting/receiving signals to/from the display device 100 according to the Bluetooth communication standards. Additionally, the remote control device 200 can include a Near Field Communication (NFC) module 227 for transmitting/receiving signals to/from the display device 100 according to the NFC communication standards and a WLAN module 229 for transmitting/receiving signals to/from the display device 100 according to the Wireless LAN (WLAN) communication standards.

Additionally, the remote control device 200 can transmit signals containing information on a movement of the remote control device 200 to the display device 100 through the wireless communication unit 220.

Moreover, the remote control device 200 can receive signals transmitted from the display device 100 through the RF module 221 and if necessary, can transmit a command on power on/off, channel change, and volume change to the display device 100 through the IR module 223.

The user input unit 230 can be configured with a keypad button, a touch pad, or a touch screen. A user can manipulate the user input unit 230 to input a command relating to the display device 100 to the remote control device 200. If the user input unit 230 includes a hard key button, a user can input a command relating to the display device 100 to the remote control device 200 through the push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 can be a button for recognizing a user's fingerprint. According to an embodiment of the present invention, the fingerprint recognition button 212 can perform a push operation and receive a push operation and a fingerprint recognition operation. The power button 231 can be button for turning on/off the power of the display device 100. The home button 232 can be a button for moving to the home screen of the display device 100. The live button 233 can be a button for displaying live broadcast programs. The external input button 234 can be a button for receiving an external input connected to the display device 100. The voice adjustment button 235 can be a button for adjusting the size of a volume output from the display device 100. The voice recognition button 236 can be a button for receiving user's voice and recognizing the received voice. The channel change button 237 can be a button for receiving broadcast signals of a specific broadcast channel. The check button 238 can be a button for selecting a specific function and the back button 239 can be a button for returning to a previous screen.

Again, referring to FIG. 2.

If the user input unit 230 includes a touch screen, a user can touch a soft key of the touch screen to input a command relating to the display device 100 to the remote control device 200. Additionally, the user input unit 230 can include various kinds of input means manipulated by a user, for example, a scroll key and a jog key, and this embodiment does not limit the scope of the present invention.

The sensor unit 240 can include a gyro sensor 241 or an acceleration sensor 243 and the gyro sensor 241 can sense information on a movement of the remote control device 200.

For example, the gyro sensor 241 can sense information on an operation of the remote control device 200 on the basis of x, y, and z axes and the acceleration sensor 243 can sense information on a movement speed of the remote control device 200. Moreover, the remote control device 200 can further include a distance measurement sensor and sense a distance with respect to the display unit 180 of the display device 100.

The output unit 250 can output image or voice signals in response to manipulation of the user input unit 230 or image or voice signals corresponding to signals transmitted from the display device 100. A user can recognize whether the user input unit 230 is manipulated or the display device 100 is controlled through the output unit 250.

For example, the output unit 250 can include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste can be reduced. The power supply unit 260 can resume the power supply if a predetermined key provided at the remote control device 200 is manipulated.

The storage unit 270 can store various kinds of programs and application data necessary for control or operation of the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 can store, in the storage unit 270, information on a frequency band for transmitting/receiving signals to/from the display device 100 paired with the remote control device 200 and refer to it.

The control unit 280 controls general matters relating to control of the remote control device 200. The control unit 280 can transmit a signal corresponding to a predetermined key manipulation of the user input unit 230 or a signal corresponding to movement of the remote control device 200 sensed by the sensor unit 240 to the display device 100 through the wireless communication unit 220.

Additionally, the sound acquisition unit 290 of the remote control device 200 can obtain voice.

The sound acquisition unit 290 can include at least one microphone and obtain voice through the microphone 291.

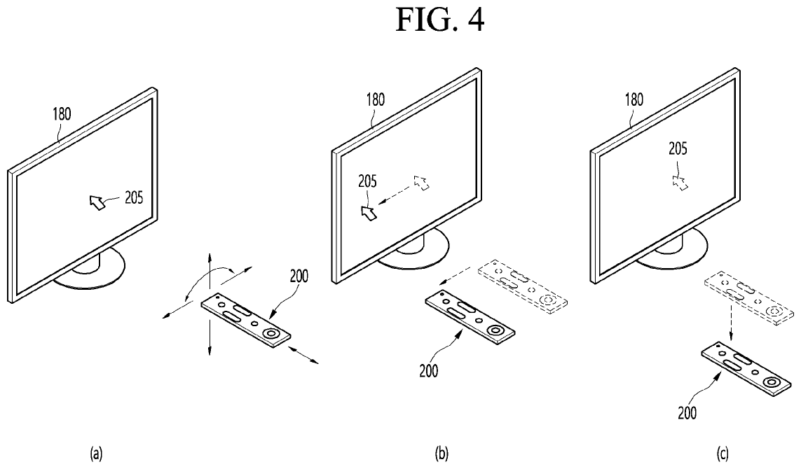

Then, referring to FIG. 4.

FIG. 4 is a view of utilizing a remote control device according to an embodiment of the present invention.

FIG. 4(a) illustrates that a pointer 205 corresponding to the remote control device 200 is displayed on the display unit 180.

A user can move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 can be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 can calculate the coordinates of the pointer 205 from the information on the movement of the remote control device 200. The display device 100 can display the pointer 205 to match the calculated coordinates.

FIG. 4(c) illustrates that while a specific button in the remote control device 200 is pressed, a user moves the remote control device 200 away from the display unit 180. Thus, a selection area in the display unit 180 corresponding to the pointer 205 can be zoomed in and displayed larger.

On the other hand, if a user moves the remote control device 200 close to the display unit 180, a selection area in the display unit 180 corresponding to the pointer 205 can be zoomed out and displayed in a reduced size.

On the other hand, if the remote control device 200 is moved away from the display unit 180, a selection area can be zoomed out and if the remote control device 200 is moved closer to the display unit 180, a selection area can be zoomed in.

Additionally, if a specific button in the remote control device 200 is pressed, recognition of a vertical or horizontal movement can be excluded. That is, if the remote control device 200 is moved away from or closer to the display unit 180, the up, down, left, or right movement cannot be recognized and only the back and forth movement can be recognized. While a specific button in the remote control device 200 is not pressed, only the pointer 205 is moved according to the up, down, left or right movement of the remote control device 200.

Moreover, the moving speed or moving direction of the pointer 205 can correspond to the moving speed or moving direction of the remote control device 200.

Furthermore, a pointer in this specification means an object displayed on the display unit 180 in response to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 can be displayed in correspondence to one point of a horizontal axis and a vertical axis on the display unit 180 and also can be displayed in correspondence to a plurality of points such as a line and a surface.

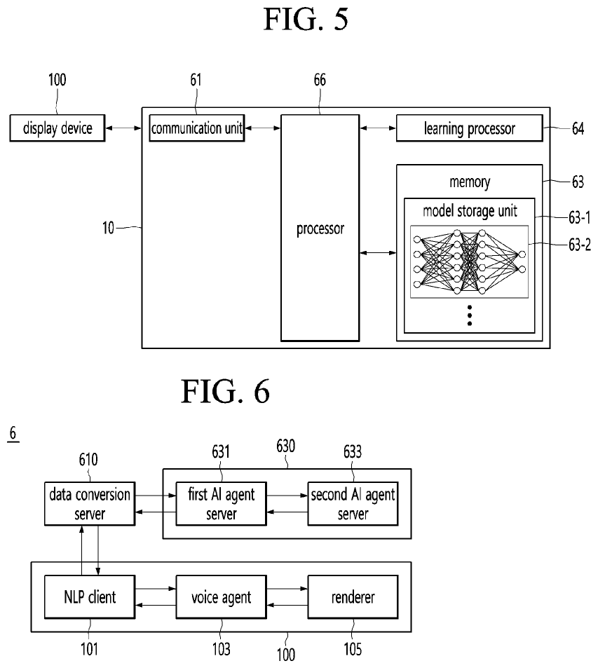

FIG. 5 is a block diagram illustrating the configuration of an AI server according to an embodiment of the present disclosure.

Referring to FIG. 5, an artificial intelligence (AI) server 10 may refer to a device that learns an artificial neural network using a machine learning algorithm or uses the learned artificial neural network.

Here, the AI server 10 may be composed of a plurality of servers to perform distributed processing, or may be defined as a 5G network. In this case, the AI server 10 may be included as a part of the display device 100 and perform at least part of the AI processing together.

The AI server 10 may include a communication unit 61, a memory 63, a learning processor 64 and a processor 66, and the like.

The communication unit 61 may transmit/receive data with an external device such as the display device 100.

The memory 63 may include a model storage unit 63-1. The model storage unit 63-1 may store a model (or artificial neural network, 63-2) being learned or learned through the learning processor 64.

The learning processor 64 may train the artificial neural network 63-2 using the learning data. The learning model may be used while loaded in the AI server 10 of the artificial neural network, or may be loaded and used in an external device such as the display device 100.

A learning model can be implemented in hardware, software, or a combination of hardware and software. If part or all of the learning model is implemented as software, one or more instructions constituting the learning model may be stored in the memory 63.

The processor 66 may infer a result value for new input data using the learning model, and generate a response or control command based on the inferred result value.

FIG. 6 is a diagram for explaining the configuration of an artificial intelligence system according to another embodiment of the present disclosure.

Referring to FIG. 6, the artificial intelligence system 6 may include a display device 100, a data conversion server 610, and an NLP server 630.

The display device 100 may transmit voice data corresponding to a voice command uttered by a user to the data conversion server 610.

The data conversion server 610 may receive voice data from the display device 100. The data conversion server 610 may convert the received voice data into text data.

The data conversion server 610 may convert the intended execution result in text form received from the NLP server 630 into voice data in audio form, and transmit the converted voice data to the display device 100.

The data conversion server 610 may transmit voice data representing AI agent change to the display device 100.

NLP (Natural Language Process) server 630 may include a first AI agent server 631 and a second AI agent server 633.

The NLP server 630 may receive text data from the data conversion server 610 and analyze the intent of the received text data using a natural language processing engine.

NLP server 630 may include one or more AI agent servers.

Each AI agent server may generate intention analysis information by sequentially performing a morpheme analysis step, a syntax analysis step, a dialogue act analysis step, and a dialog processing step on text data.

The morpheme analysis step is a step of classifying text data corresponding to a voice uttered by a user into morpheme units, which are the smallest units having meaning, and determining what parts of speech each classified morpheme has.

The syntactic analysis step is a step of classifying the text data into noun phrases, verb phrases, adjective phrases, etc. using the result of the morpheme analysis step, and determining what kind of relationship exists between the classified phrases.

Through the syntactic analysis step, the subject, object, and modifiers of the voice uttered by the user may be determined.

The dialogue act analysis step is a step of analyzing the intention of the voice uttered by the user by using the result of the syntax analysis step. Specifically, the dialogue act analysis step is a step of determining the intent of the sentence, such as whether the user asks a question, makes a request, or simply expresses emotion.

The dialog processing step is a step of determining whether to respond to the user's utterance, respond to the user's utterance, or ask a question asking for additional information by using the result of the dialogue act analysis step.

After the conversation processing step, each AI agent server may generate intention analysis information including one or more of a response to the intention uttered by the user, a response, and an inquiry for additional information.

The NLP server 630 may include a first AI agent server 631 and a second AI agent server 633.

The first AI agent server 631 may be a server that provides a natural language processing service through a manufacturer other than the manufacturer of the display device 100.

The second AI agent server 633 may be a server that provides a natural language processing service through a manufacturer of the display device 100.

Each of the first AI agent server 631 and the second AI agent server 633 may include components of the AI server 10 shown in FIG. 5.

The data conversion server 610 may transmit text data to the first AI agent server 631.

The first AI agent server 631 may acquire the intention of the text data and determine whether an operation corresponding to the acquired intention can be processed.

If it is determined that the first AI agent server 631 can process an operation corresponding to the acquired intention, it may obtain an intention analysis result corresponding to the intention.

If it is determined that the first AI agent server 631 cannot process the operation corresponding to the obtained intention, it may transmit the intention of the text data to the second AI agent server 633.

The second AI agent server 633 may obtain an intention analysis result corresponding to the intention of the received text data, and transmit the obtained intention analysis result to the first AI agent server 631.

The first AI agent server 631 may transmit the intent analysis result to the data conversion server 610.

The data conversion server 610 may transmit the intention analysis result to the NLP client 101 of the display device 100.

The display device 100 may further include an NLP client 101, a voice agent 103 and a renderer 105.

NLP client 101, voice agent 103 and renderer 105 may be included in the control unit 170 shown in FIG. 1.

As another example, NLP client 101 may be included in the network interface unit 133 shown in FIG. 1.

The NLP client 101 may communicate with the data conversion server 610.

The voice agent 103 may receive a signal for entering the voice recognition mode from the remote control device 200 and activate the operation of the microphone provided in the display device 100 according to the received signal.

The voice agent 103 may transmit a voice command received from the microphone provided in the display device 100 or a voice command received from the remote control device 200 to the NLP client 101.

The voice agent 103 may receive intention analysis result information or search information received from the NLP server 630 by the NLP client 101.

The voice agent 103 may execute an application or perform a function corresponding to a button key of the remote control device 200 based on the intention analysis result information.

The voice agent 103 may be included in the configuration of the NLP client 103.

The renderer 105 may generate a UI through a GUI module to display the received search information on the display unit 180 and output the generated UI to the display unit 180.

Depending on the embodiment, the data conversion server 610 may be included in the NLP server 630.

In addition, each of the first AI agent server 631 or the second AI agent server 633 may be regarded as one NLP server.

Although two AI agent servers are exemplified in FIG. 6, there is no need to be limited thereto, and more AI agent servers may exist.

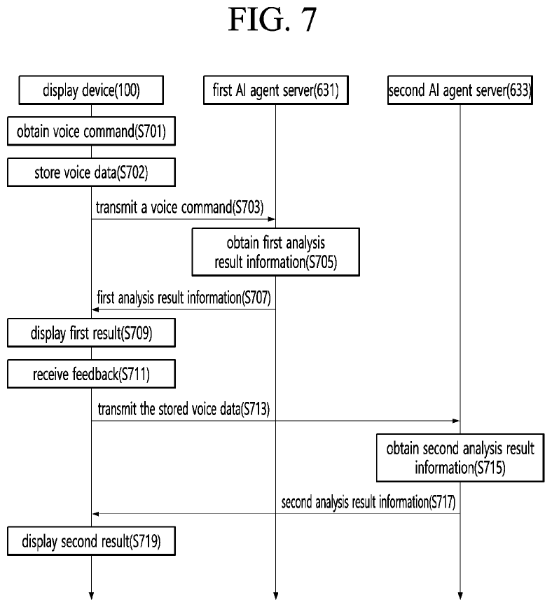

FIG. 7 is a ladder diagram for a method of operating an artificial intelligence system according to an embodiment of the present disclosure.

Hereinafter, a method of operating a system according to an embodiment of the present disclosure will be described with reference to FIGS. 5 and 6.

In addition, below, the AI agent may be hardware or software capable of recognizing a voice command uttered by a user and providing analysis result information according to the intention of the recognized voice command.

The AI agent may provide a voice recognition service through an application installed on the display device 100.

One AI agent may correspond to one company providing voice recognition service.

A plurality of applications corresponding to each of a plurality of AI agents may be installed in the display device 100.

A plurality of AI agents may be provided in the display device 100 or the NLP server 630.

Meanwhile, some of the steps of FIG. 7 may be performed simultaneously or the order of some steps may be reversed.

Referring to FIG. 7, the control unit 170 of the display device 100 obtains a voice command uttered by the user (S701).

In one embodiment, the control unit 170 may receive a voice command uttered by a user through a microphone (not shown) provided in the display device 100.

In another embodiment, the control unit 170 may receive a voice command from the remote control device 200.

The control unit 170 of the display device 100 stores voice data corresponding to the voice command in the storage unit 140 (S702).

The control unit 170 may convert analog voice data corresponding to a voice command into digital voice data.

More specifically, the control unit 170 may include an audio input processor, and the audio input processor may generate an audio stream corresponding to a voice command. The audio stream may be a voice waveform corresponding to a voice command.

The control unit 170 may encode the voice waveform through a pulse code modulation (PCM) method and obtain a PCM file according to an encoding result.

A PCM file may directly correspond to voice data.

The control unit 170 may store the PCM file in the storage 140. The PCM file may be used to be transmitted to another AI agent server later, if the result of the intention corresponding to the voice command uttered by the user is an unexpected result.

The control unit 170 of the display device 100 transmits a voice command to the first AI agent server 631 (S703).

That is, what is transmitted to the first AI agent server 631 may be a voice command itself rather than stored voice data.

The first AI agent server 631 may be a server corresponding to the first AI agent.

The first AI agent server 631 may be a server corresponding to an AI agent selected by a hybrid provision method or an AI agent selected by a user according to a user-selective provision method.

The control unit 170 may transmit the PCM file corresponding to the voice command uttered by the user to the first AI agent server 631 through the network interface unit 133.

The control unit 170 may transmit voice data stored in the storage 140 to the first AI agent server 631 in order to request an analysis result for a voice command uttered by a user.

The control unit 170 may transmit voice data to the first AI agent server 631 through the network interface unit 133. Voice data may be a PCM file.

The first AI agent server 631 obtains first analysis result information, which is an analysis result of the voice data, based on the received voice data (S705).

The first AI agent server 631 may convert voice data into text data and perform intention analysis on the converted text data.

In one embodiment, the first AI agent server 631 may convert voice data into text data using a speech to text (STT) engine.

In another embodiment, the display device 100 may transmit text data to the STT server, and the first AI agent server 631 may receive the text data from the STT server.

The first AI agent server 631 may obtain an analysis result for text data using a natural language processing engine.

The first AI agent server 631 may obtain first analysis result information reflecting the analysis result of voice data.

Here, the first analysis result information may include a result in which the intention of the user's voice command is not properly reflected. This may be because the user's voice command is a command that the first AI agent server 631 cannot process.

In another embodiment, the first analysis result information may further include a text conversion result (STT result) of a voice command. In this case, the display device 100 may transmit the STT result instead of the PCM file to the second AI agent server 633 later. Accordingly, as the second AI agent server 633 performs the intention analysis process without the STT process, the speech recognition execution speed can be increased.

The first AI agent server 631 transmits the obtained first analysis result information to the display device 100 (S707).

The control unit 170 of the display device 100 displays the first result on the display unit 180 based on the received first analysis result information (S709).

The first result may be a result analyzed through the first analysis result information.

The first result based on the first analysis result information may be a result in which the user's intention for the voice command is not properly reflected.

The control unit 170 of the display device 100 receives the feedback (S711) and transmits the stored voice data to the second AI agent server 633 based on the received feedback (S713).

In one embodiment, the feedback may be a request to select an AI agent other than the first AI agent.

In another embodiment, the feedback may be the same voice command as the voice command uttered in step S701.

The display device 100 may receive the user's feedback from the remote control device 200 or directly receive it. The user's feedback may be a selection of a button provided on the remote control device 200 or a voice command. A button provided on the remote control device 200 may be a button for selecting a specific AI agent.

The remote control device 200 may have a plurality of buttons corresponding to each of a plurality of AI agents.

In one embodiment, the control unit 170 may transmit the PCM file stored in the storage 140 to the second AI agent server 633 if the received feedback is a request for selecting the second AI agent.

The reason why the control unit 170 transmits the PCM file to the second AI agent server 633 is that STT results (text data) are not shared between each AI agent server as a policy.

If the received feedback is a request for selecting the second AI agent, the control unit 170 may determine that the intention analysis result of the voice command through the first AI agent is incorrect.

In another embodiment, if the received feedback indicates that the voice command has been received again, the control unit 170 may recognize the feedback as a request for selecting another AI agent.

In this case, the control unit 170 may select either the second AI agent or the third AI agent.

The second AI agent server 633 obtains second analysis result information based on the voice data received from the display device 100 (S715).

The second AI agent server 633 may convert voice data into text data and perform intention analysis on the converted text data using a natural language processing engine.

The second AI agent server 633 transmits the obtained second analysis result information to the display device 100 (S717).

The display device 100 displays the second result on the display unit 180 based on the received second analysis result information (S719).

The second result based on the second analysis result information may be a result in which the user's intention for the voice command is properly reflected.

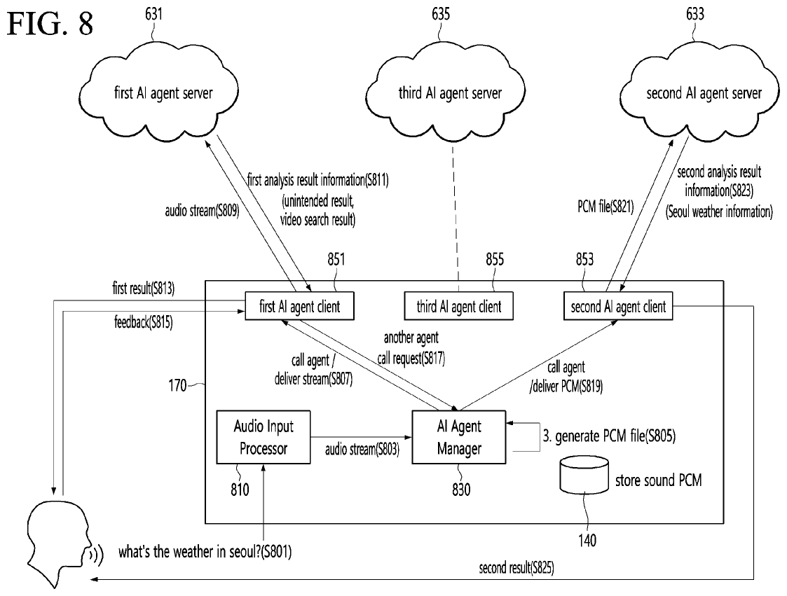

FIG. 8 is a diagram explaining a process in which an artificial intelligence system operates in response to a voice command uttered by a user.

Referring to FIG. 8, the artificial intelligence system may include a first AI agent server 631, a second AI agent server 633, a third AI agent server 635, and a display device 100.

The control unit 170 of the display device 100 may include an audio input processor 810, an AI agent manager 830, and a plurality of AI agent clients 851, 853, and 855.

The AI agent manager 830 may have the same configuration as the voice agent 103 of FIG. 6.

Each of the plurality of AI agent clients 851, 853, 855 may have the same configuration as the NLP client 101 of FIG.

In FIG. 8, it is assumed that the user utters a voice command of <what's the weather in seoul>(S801). Also, it is assumed that the display device 100 provides a voice recognition service through the first AI agent.

The audio input processor 810 may generate an audio stream by pre-processing a user's voice command.

The audio input processor 810 may deliver the generated audio stream to the AI assistant manager 830 (S803).

The AI agent manager 830 may generate a PCM file based on the audio stream (S805).

The AI agent manager 830 may generate a PCM file by using a pulse code modulation method for an audio stream. The PCM file may be a file obtained by digitizing the original sound for voice.

The AI agent manager 830 may store the PCM file in the storage unit 140. The storage unit 140 may be included in the control unit 170 or may be provided separately from the control unit 170.

The AI agent manager 830 may deliver the first AI agent client call command and audio stream corresponding to the first AI agent to the first AI agent client 851 (S807).

The first AI agent client 851 may transmit the received audio stream to the first AI agent server 631 (S809).

The first AI agent server 631 may convert the audio stream into text data and perform natural language processing on the converted text data.

The first AI agent server 631 may obtain first analysis result information that is an analysis result for natural language processing.

The first AI agent server 631 may transmit the first analysis result information to the first AI agent client 851 (S811). The first analysis result information may include an unintended result of a voice command uttered by a user. That is, the first analysis result information may include a search result of a video.

The first AI agent client 851 may display a first result based on the first analysis result information on the display unit 180 (S813).

The first result indicates a video search result and may include a video list.

The first AI agent client 851 may receive the user's feedback on the first result (S815).

In one embodiment, the feedback may be a request to select another AI agent. The feedback may be for requesting an analysis result of a voice command uttered by the user through another AI agent.

In another embodiment, the feedback may be a request indicating dissatisfaction with the first result.

The first AI agent client 851 may transmit another client call request based on the received feedback to the AI agent manager 830 (S817). Another client call request may be a request to obtain an analysis result of a voice command uttered by a user through another AI agent.

Another client call request may be a request to call a client corresponding to an AI agent included in the feedback. The feedback may include information about the AI agent selected by the user.

The AI agent manager 830 may transmit a client call and a pre-stored pcm file to the second AI agent client 853 based on another client call request received from the first AI agent client 851 (S819).

The second agent client 853 may transmit the received pcm file to the second AI agent server 633 (S821).

The second AI agent server 633 may convert the pcm file into text data, perform natural language processing analysis on the converted text data, and obtain second analysis result information.

The second analysis result information may include weather information of Seoul suitable for the intention of the voice command uttered by the user.

The second AI agent server 633 may transmit the second analysis result information to the second AI agent client 853 (S823).

The second AI agent client 853 may display the second result on the display unit 180 based on the second analysis result information (S825).

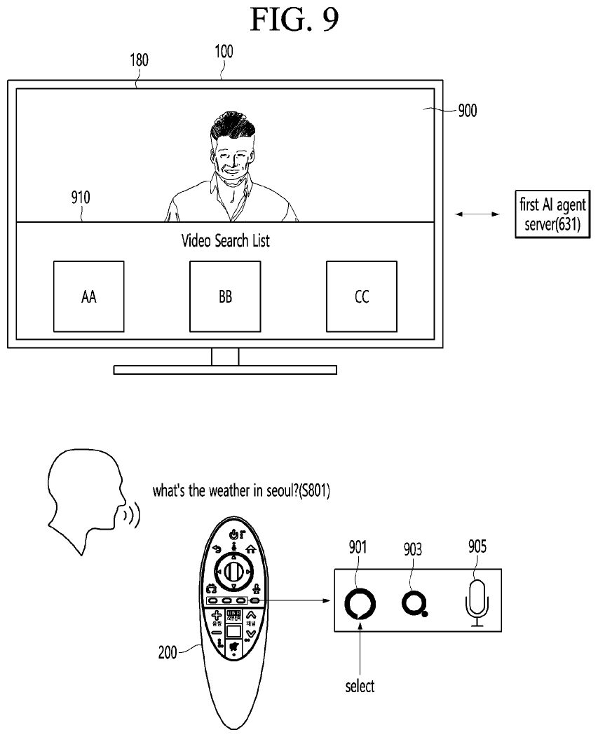

FIGS. 9 to 13 are diagrams illustrating examples of providing a second result according to a user's feedback on a first result according to various embodiments of the present disclosure.

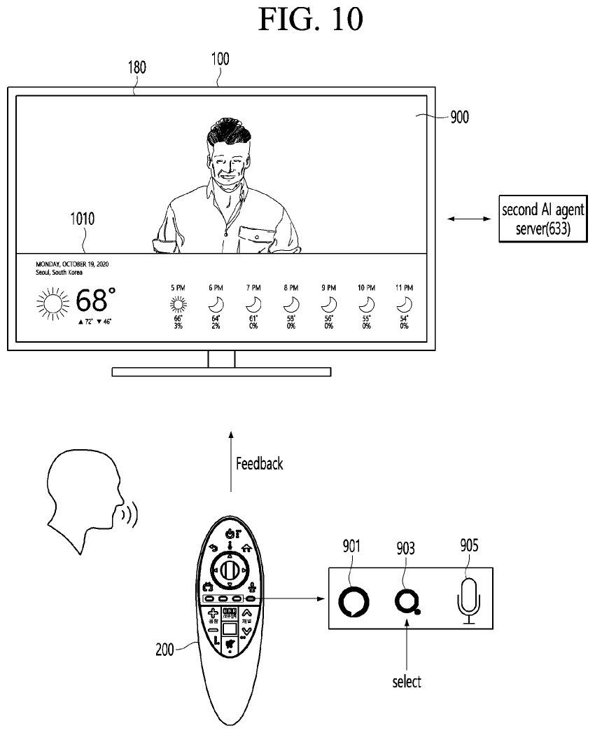

First, FIGS. 9 and 10 are diagrams illustrating an example in which user feedback is provided through a button provided in the remote control device 200.

The remote control device 200 may include a plurality of AI agent buttons 901, 903, and 905.

Each of the plurality of AI agent buttons 901, 903, and 905 may be a button corresponding to each of the plurality of AI agents.

The first AI agent button 901 may be a button for receiving a voice recognition result from the first AI agent server 631.

The second AI agent button 903 may be a button for receiving a voice recognition result from the second AI agent server 633.

The third AI agent button 905 may be a button for receiving a voice recognition result from the third AI agent server 635.

Referring to FIG. 9, the user utters a voice command of <what's the weather in seoul> while pressing the first AI agent button 901 provided on the remote control device 200.

The remote control device 200 may transmit a first AI agent selection command and a voice command (or a voice signal corresponding to the voice command) to the display device 100.

The display device 100 may convert the voice command received from the remote control device 200 into a PCM file through a pulse code modulation method and store it.

The display device 100 may transmit a voice command to the first AI agent server 631 according to the first AI agent selection command from the remote control device 200.

The first AI agent server 631 may obtain first analysis result information by performing intention analysis on the user's voice command. The first analysis result information may include a video search result in which the first AI agent server 631 does not reflect the user's intention.

The display device 100 may receive first analysis result information on the voice command from the first AI agent server 631.

The display device 100 may display a video search result 910 based on the first analysis result received from the first AI agent server 631 on the display unit 180.

The video search result 910 may be displayed overlapping the content video 900.

The user intended the weather information of Seoul, but did not get the desired result.

The user may transmit feedback about the video search result 910 to the display device 100 through the remote control device 200.

For example, the user may press the second AI agent button 903 provided on the remote control device 200.

The remote control device 200 may recognize the selection command of the second AI agent as feedback and transmit it to the display device 100.

The display device 100 may transmit the PCM file stored in the second AI agent server 633 according to the second AI agent selection command received from the remote control device 200.

That is, the user does not need to re-utter the voice command of <what's the weather in seoul>.

The second AI agent server 633 may convert the PCM file into text data and obtain second analysis result information on the converted text data.

The second analysis result information may include weather information of Seoul.

The display device 100 may receive second analysis result information from the second AI agent server 933 and display weather information 1010 of Seoul based on the received second analysis result information.

As such, according to an embodiment of the present disclosure, even if a user does not obtain a desired result for a voice command from any one AI agent, the user can easily obtain a desired result from another AI agent without having to re-utter the voice command.

Accordingly, the user can enjoy a more improved voice recognition experience.

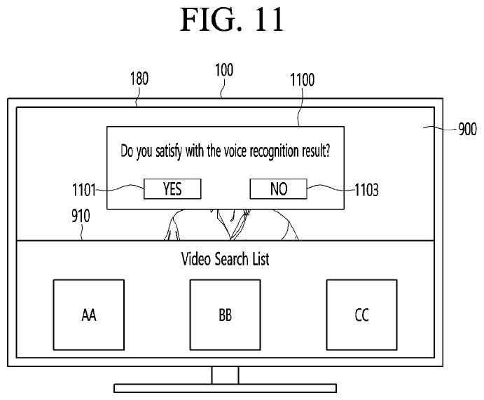

FIG. 11 is a diagram for explaining an example of receiving a user's feedback through a pop-up window according to an embodiment of the present disclosure.

In FIG. 11, the embodiment of FIG. 9 is borrowed. That is, the display device 100 displays the video search result 910 received from the first AI agent server 631 on the display unit 180.

At the same time, the display device 100 may display on the display unit 180 a pop-up window 1100 asking whether or not to be satisfied with the voice recognition result of the voice command.

The pop-up window 1100 may include a text asking whether or not to be satisfied with a voice recognition result of a voice command, an agree button 1101 and a non-agree button 1103.

The user may select the non-agree button 1103.

The display device 100 may transmit the stored PCM file to another AI agent server according to a command for selecting the non-agree button 1103.

The display device 100 may recognize a command to select the non-agree button 1103 as feedback of dissatisfaction with the voice recognition result.

The display device 100 may transmit the PCM file to the second AI agent server 633 or the third AI agent server 635.

The display device 100 may select an AI agent server corresponding to an AI agent with a high frequency of use as a transfer target of the PCM file.

The display device 100 may select an AI agent server corresponding to an AI agent according to preset priorities as a transfer target of the PCM file.

The display device 100 may receive and display a desired analysis result for a voice command from the AI agent server that has transmitted the PCM file.

In this way, according to an embodiment of the present disclosure, the user can check the intended result of the voice command without the need to utter the voice command again through feedback on the voice recognition result.

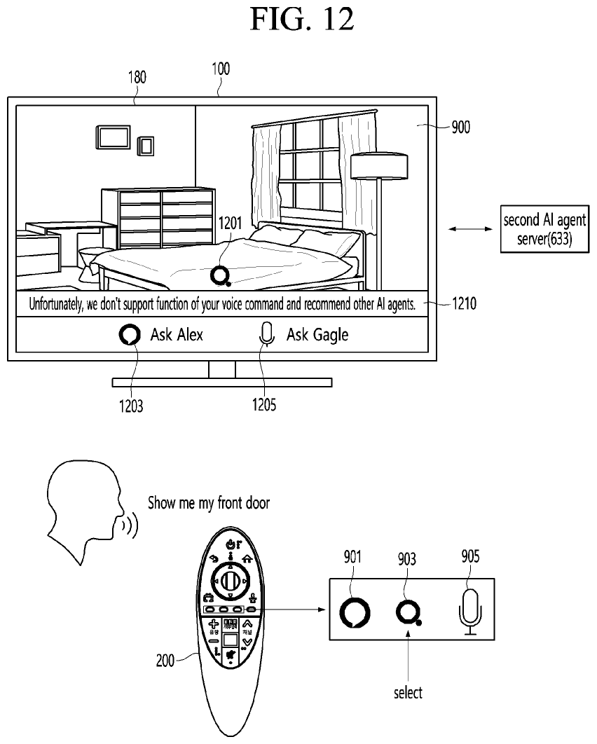

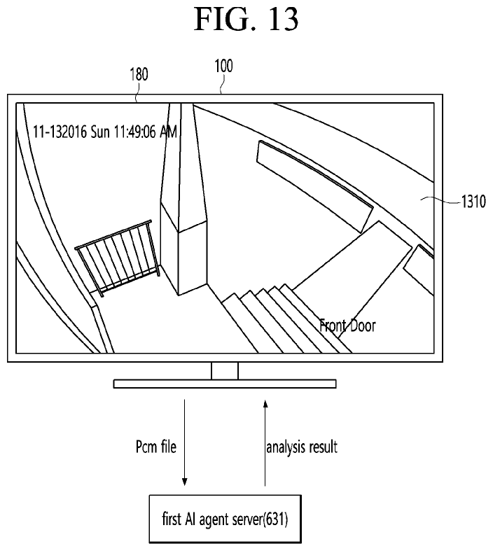

FIGS. 12 and 13 are diagrams illustrating an example of recommending selection of another AI agent if an analysis result of a user's voice command is not provided according to another embodiment of the present disclosure.

Referring to FIG. 12, the user long-presses the second AI agent button 903 provided on the remote control device 200 and then utters a voice command of <Show me my front door>.

The display device 100 may receive a selection command and a voice command of the second AI agent from the remote control device 200.

The display device 100 may display an icon 1201 identifying the second AI agent.

The display device 100 may acquire and store a PCM file corresponding to the voice command.

The display device 100 may transmit a voice command to the second AI agent server 633.

The second AI agent server 633 may convert the voice command into text data and obtain an analysis result for the converted text data.

As a result of the analysis, the second AI agent server 633 may transmit analysis result information indicating this to the display device 100 if the function corresponding to the voice command is not supported.

Based on the received analysis result information, the display device 100 may display a notification 1210 indicating that a voice command is not supported.

In addition, the notification 1210 may further include text indicating that other AI agents will be recommended.

At the same time, the display device 100 may display a plurality of AI agent recommendation buttons 1203 and 1205 on the display unit 180 to recommend selection of other AI agents.

The first AI agent recommendation button 1203 may be a button for selecting a first AI agent, and the third AI agent recommendation button 1205 may be a button for selecting a third AI agent.

The display device 100 may receive a command to select the first AI agent recommendation button 1203 from the remote control device 200.

As shown in FIG. 13, the display device 100 may transmit the pre-stored PCM file to the first AI agent server 631 corresponding to the first AI agent.

The first AI agent server 631 may obtain an analysis result through a natural language processing engine based on the PCM file and transmit the analysis result to the display device 100.

Here, the analysis result may be a result of requesting a camera to show the situation in front of the door.

The display device 100 receives an image taken by a camera located in front of the door based on the analysis result received from the first AI agent server 631, and displays the received image 1310 on the display unit 180.

In another embodiment, the first AI agent server 631 may receive a captured image from a camera in front of the door and transmit the received image to the display device 100. The display device 100 may display the image received from the first AI agent server 631.

In this way, according to an embodiment of the present disclosure, in response to a user's one-time utterance command, an image that several AI assistants interact with and talk to each other is given to provide the user with an effect in which the display device 100 looks a little smarter.

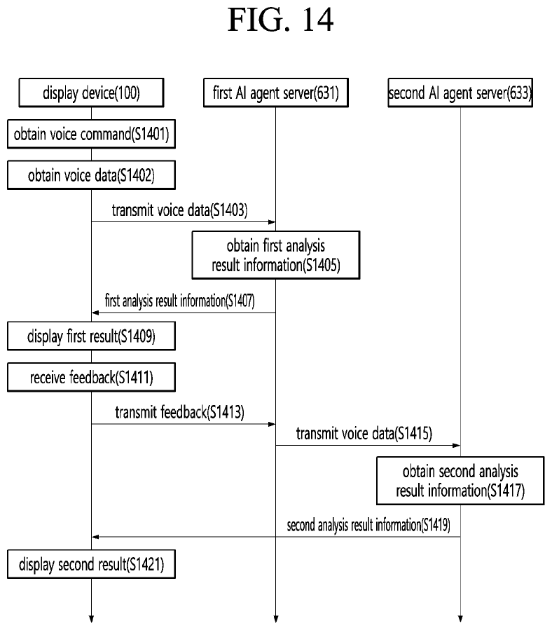

FIG. 14 is a ladder diagram for a method of operating an artificial intelligence system according to another embodiment of the present disclosure.

In particular, FIG. 14 is a diagram for explaining an embodiment in which an analysis result may be provided after calling another AI agent through communication between AI agent servers.

In FIG. 14, detailed descriptions of steps overlapping those of FIG. 7 are replaced with those of FIG. 7.

The control unit 170 of the display device 100 obtains a voice command uttered by the user (S1401).

The control unit 170 of the display device 100 obtains voice data corresponding to the voice command (S1402).

Voice data may be a PCM file.

The control unit 170 may convert a voice signal of a voice command into a PCM file through a pulse code modulation method.

The control unit 170 of the display device 100 transmits voice data to the first AI agent server 631 (S1403).

That is, unlike the embodiment of FIG. 7, the control unit 170 may transmit a PCM file rather than a voice command to the first AI agent server 631.

That is, the control unit 170 may directly transmit the generated PCM file to the first AI agent server 631 without storing it in the storage unit 140. In this case, the capacity of the storage unit 140 can be reduced by the same amount as the storage capacity of the PCM file.

The first AI agent server 631 obtains first analysis result information, which is an analysis result of the voice data, based on the received voice data (S1405).

The first AI agent server 631 may store the PCM file received from the display device 100 in the memory 63.

The first AI agent server 631 transmits the obtained first analysis result information to the display device 100 (S1407).

The control unit 170 of the display device 100 displays the first result on the display unit 180 based on the received first analysis result information (S1409).

The control unit 170 of the display device 100 receives the feedback (S1411) and transmits the received feedback to the first AI agent server 631 (S1413).

In one embodiment, the feedback may include a request to select another AI agent. For example, the feedback may include a request to select a second AI agent.

Based on the feedback, the first AI agent server 631 transmits the stored voice data to the second AI agent server 633 (S1415).

That is, the first AI agent server 631 may transmit the PCM file to the second AI agent server 633 according to the selection request of the second AI agent included in the feedback.

The second AI agent server 633 obtains second analysis result information based on the voice data received from the second AI agent server 633 (S1415).

The second AI agent server 633 transmits the obtained second analysis result information to the display device 100 (S1417).

The display device 100 displays the second result on the display unit 180 based on the received second analysis result information (S1419).

In this way, according to an embodiment of the present disclosure, the display device 100 does not need to store the PCM file, so storage capacity can be reduced. In addition, the user can conveniently receive the analysis result of the voice command without re-uttering the voice command.

According to an embodiment of the present disclosure, the above-described method can be implemented as a processor-readable code in a medium on which a program is recorded. Examples of media readable by the processor include ROM, RAM, CD-ROM, magnetic tape, floppy disk, and optical data storage devices, and those be implemented in the form of carrier waves (eg, transmission through the Internet).

The display device described above is not limited to the configuration and method of the above-described embodiments, but the above embodiments may be configured by selectively combining all or part of each embodiment so that various modifications can be made.

1. A display device, comprising:
a storage unit;
a display unit;
a network interface unit configured to communicate with a first server or a second server; and
a control unit configured to:
store voice data corresponding to a voice command uttered by a user in the storage unit,
transmit the voice command to the first server, receive first analysis result information of the voice command from the first server,
display a first result based on the received first analysis result information on the display unit,
transmit the stored voice data to the second server if a user's feedback is received,
receive a second analysis result information of a command from the second server, and
display a second result based on the received second analysis result information on the display unit.

2. The display device of claim 1, wherein the feedback is a request indicating that the first result includes information not suitable for an intent of the voice command.

3. The display device of claim 1, wherein the feedback includes a command for selecting a second AI agent corresponding to the second server other than the first AI agent corresponding to the first server.

4. The display device of claim 3, wherein the control unit receives the feedback from the remote control device.

5. The display device of claim 3, wherein the control unit further displays AI agent buttons indicating the first result and the second AI agent on the display,
the feedback is a command for selecting the AI agent button.

6. The display device of claim 1, wherein the control unit further displays a pop-up window on the display unit inquiring whether or not the first result is satisfied, and obtain a selection of the non-agree button included in the pop-up window as the feedback.

7. The display device of claim 1, wherein the control unit converts the voice command into the voice data through a pulse code modulation (PCM) method.

8. The display device of claim 1, wherein the first result is a result that does not meet the intent of the voice command, the second result is a result that meets the intent of the voice command.

9. A display device, comprising:
a display unit;
a network interface unit configured to communicate with a first server or a second server; and
a control unit configured to:
transmit a voice data corresponding to a voice command spoken by a user to the first server,
receive a first analysis result information of the voice command from the first server,
display a first result based on the received first analysis result information on the display unit,
receive a feedback from the user,
transmit the received feedback to the first server,
receive a second analysis result information of the voice command from the second server,
display a second result based on the received second analysis result information on the display unit.

10. The display device of claim 9, wherein the feedback is a request indicating that the first result includes information not suitable for an intent of the voice command.

11. The display device of claim 9,
the feedback
including a command for selecting a second AI agent corresponding to the second server
other than the first AI agent corresponding to the first server
display device.

12. The display device of claim 11, wherein the control unit receives the feedback from the remote control device.

13. The display device of claim 11, wherein the control unit further displays AI agent buttons indicating the first result and the second AI agent on the display, the feedback is a command for selecting the AI agent button.

14. The display device of claim 9, wherein the control unit further displays a pop-up window on the display unit inquiring whether or not the first result is satisfied, and obtain a selection of the non-agree button included in the pop-up window as the feedback.

15. The display device of claim 9, wherein the control unit converts the voice command into the voice data through a pulse code modulation (PCM) method.
